(19) United States
(12) Patent Application Publication
(10) Pub. No.: US 2012/0191368 A1
(43) Pub. Date: Jul. 26, 2012

(54) System and Method for Sampling Traces of Explosives

(75) Inventors: Gerald I. Schofield, McKinney, TX (US); James E. Tollefsrud, McKinney, TX (US)

(73) Assignee: Raytheon Company, Waltham, MA (US)

(21) Appl. No.: 13/151,976

(22) Filed: Jun. 2, 2011

Related U.S. Application Data
(60) Provisional application No. 61/353,536, filed on Jun. 10, 2010.

(51) Int. Cl. G06F 19/00

(52) U.S. Cl. 702/22

(57) ABSTRACT

According to one embodiment, a method includes receiving, at a device capable of reading data stored on an object, at least a portion of the object inserted into the device. The data stored on the object includes data for use in a transaction. The method further includes collecting, at the device, residue from the object in response to at least the portion of the object being inserted into the device. The method further includes determining that the residue comprises an explosive material. The method further includes generating data that is representative of the explosive material. The method further includes communicating the data that is representative of the explosive material.

### RELATED APPLICATION

This application claims the benefit under 35 U.S.C. §119(e) of the priority of U.S. Provisional Application No. 61/353,536 filed Jun. 10, 2010, entitled “System and Method for Sampling Traces of Explosives.”

### TECHNICAL FIELD

This disclosure relates generally to the field of counter-terrorism and more specifically a system and method for sampling traces of explosives.

### BACKGROUND

Several types of machines have been developed to detect trace signatures of various explosive materials. These machines may employ a variety of different technologies for detecting explosive materials including, for example, scent detection, spectrometry, x-ray machines, neutron activation, and so forth. These machines, however, are deficient because they may not analyze objects that are likely to come in contact with explosive materials and they are used in situations where the user has knowledge of the fact that explosive material detection operations are occurring.

### SUMMARY OF THE DISCLOSURE

According to one embodiment, a method includes receiving, at a device capable of reading data stored on an object, at least a portion of the object inserted into the device. The data stored on the object includes data for use in a transaction. The method further includes collecting, at the device, residue from the object in response to at least the portion of the object being inserted into the device. The method further includes determining that the residue comprises an explosive material. The method further includes generating data that is representative of the explosive material. The method further includes communicating the data that is representative of the explosive material.

Certain embodiments of the disclosure may provide one or more technical advantages. For example, particular embodiments may provide explosive detection functionality to various devices that are conventionally used for reasons unrelated to explosive material detection and therefore may provide the ability to detect explosive materials on objects that typically may not be scanned for explosive materials. Furthermore, these objects may be the type of objects (such as credit cards, debit cards, and/or money) that often come in contact with a user's skin or clothing, thus increasing the chance of explosive material being transferred to the object for detection. In particular embodiments, by providing the ability to detect explosive materials at transaction-based (and financial transaction-based) devices which may be used to conduct hundreds (or thousands) of transactions a day, an increased sample size may be provided for detecting explosive materials. Additionally, various embodiments may provide analysis and detection operations without the knowledge of the user of the object, thereby increasing the chance of detecting an explosive material because the user is less likely to take precautions to prevent the transfer of explosive material residue to the object.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates an example system for detecting an explosive material according to one embodiment;

FIG. 2 illustrates an example method for detecting explosive materials according to one embodiment; and

FIG. 3 illustrates an embodiment of a computer system according to one embodiment.

### DETAILED DESCRIPTION OF THE DRAWINGS

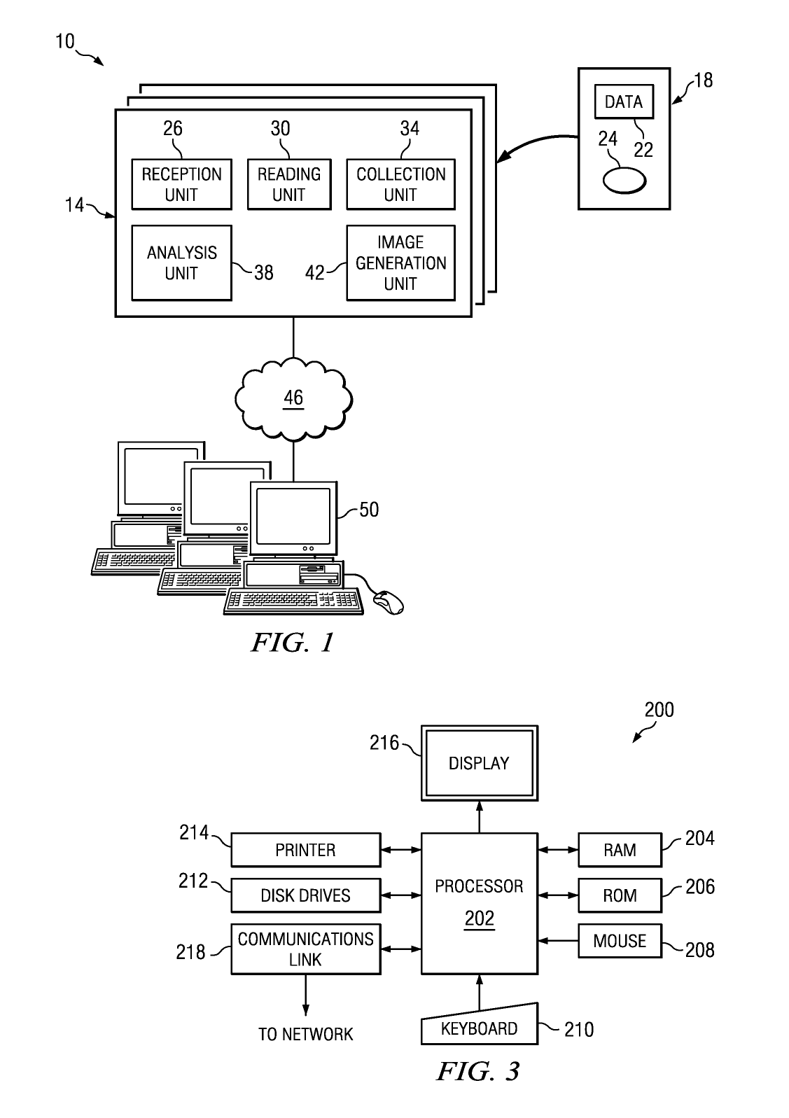

Embodiments of the present disclosure are best understood by referring to FIGS. 1 through 3 of the drawings, like numerals being used for like and corresponding parts of the various drawings.

Certain explosive materials have residue that readily sticks to and transfers from one surface to another. In certain situations, residue of a particular explosive material may be transferred to objects handled by people who came in contact with the material. As explained further below, particular embodiments may provide explosive detection functionality to various devices that conventionally have been used for reasons unrelated to explosive material detection. In certain embodiments, data collected by multiple explosive detection devices may be aggregated and collectively analyzed.

The term “explosive material” as used herein generally refers to any material that may be used in connection with generating an explosion. Example explosive materials may include those listed by the Director of the Bureau of Alcohol, Tobacco and Firearms published and revised pursuant to the provisions of section 841(d) of Title 18, United States Code (U.S.C.). See, e.g., DEPARTMENT OF JUSTICE, Bureau of Alcohol, Tobacco and Firearms, Commerce in Explosives, List of Explosive Materials (2009R-18T) at http://edocket.access.gpo.gov/2010/pdf/2010-45.pdf (last visited May 11, 2011), herein incorporated by reference. In certain embodiments, explosive material refers not only to the explosives, but also refers to blasting agents and detonators. In particular embodiments, explosive material may also refer to various cleaning agents that may be used to remove residue of other explosive material.

FIG. 1 illustrates an example of a system 10 capable of detecting an explosive material and further capable of processing data related to the detection of the explosive material. According to the illustrated embodiment, system 10 includes one or more devices 14 communicatively coupled through a network 46 to one or more managing systems 50.

Device 14 generally refers to any suitable device that conventionally has been used for reasons unrelated to explosive material detection. For example, device 14 may be a transaction-based device. Example transaction-based devices may include an identification card reader (such as a device used to restrict access to a building to only people who have a proper identification card), a ticket reader or dispenser (such as a device used to restrict access to a plane/train/ride to only people who have a valid ticket or boarding pass), any other suitable device that is used to perform a transaction, or any combination of the preceding. As another example, device 14 may be a financial transaction-based device. Example financial transaction-based devices may include any device used in a transaction dealing with financial matters, such as an automated teller machine (ATM), a credit/debit card reader (such as a device that allows a user to insert or swipe their credit/debit card in order to purchase certain products or identify themselves), a vending machine, a cash register, any other device used to conduct financial transactions, or any combination of the preceding. In particular embodiments, a financial transaction-based device may be referred to as a point-of-sale (POS) device.

Although device 14 has traditionally been used for reasons unrelated to explosive material detection, in particular embodiments, device 14 may be used to detect an explosive material on an object 18. Object 18 may generally refer to any suitable object that may be used with device 14. For example, object 18 may include a debit card, credit card, ticket, boarding pass, passport, driver's license, identification card (such as an identification card used by an employee in order to gain access to a building), money (bills and/or coins), key fob, metallic key, plastic key, any other object that may be used with device 14, or any combination of the preceding. Object 18 may allow a user to conduct a transaction with device 14. For example, object 18 may be inserted into device 14 in order to conduct a transaction (such as gaining access to a particular building) or a financial transaction (such as purchasing a product).

Object 18 may store data 22. Data 22 may generally refer to any suitable type of data that may be used to conduct a transaction with device 14, that may identify the owner of object 18, that may be stored on object 18, that may be used in any other suitable way or for any other suitable purpose, or any combination of the preceding. In particular embodiments, data 22 may include data that may be used in a transaction (or financial transaction) with device 14. For example, data 22 may include data that identifies the owner of object 18 (such as the owner's name, social security number, employee identification number, or any other suitable identifier), data that identifies one or more accounts associated with the owner of object 18, data that identifies one or more financial institutions associated with owner of object 18, data that identifies object 18 (such as data that identifies a $10 bill as a $10 bill), any other suitable data that may be used in a transaction with device 14, or any combination of the preceding. Data 22 may be stored on object 18 in any suitable manner. For example, data 22 may be stored in a magnetic strip, a bar code, a computer readable chip, a radio-frequency identification tag, any other suitable storage device or area, or any combination of the preceding.

Object 18 may further have residue 24 disposed thereon. In particular embodiments, residue 24 may include microscopic traces of an explosive material. In particular embodiments, residue 24 may be a vapor residue and/or a particulate residue. Vapor residue may refer to the gas/phase molecules that are emitted from a solid or liquid explosive because of its finite vapor pressure. Particulate residue may refer to microscopic particles of solid material that adheres to surfaces that have, directly or indirectly, come into contact with an explosive material. In particular embodiments, residue 24 may have been transferred to object 18 by a person who has come in contact with the explosive material. In particular embodiments, when object 18 is used with device 14, residue 24 may be collected and analyzed in order to determine that residue 24 includes an explosive material.

As is stated above, device 14 may be used to detect an explosive material on object 18. According to the illustrated embodiment, device 14 may generally include a reception unit 26, a reading unit 30, a collection unit 34, an analysis unit 38, and an image generation unit 42. Reception unit 26 may generally refer to any suitable unit capable of receiving at least a portion of object 18. For example, reception unit 26 may include any suitable portion of device 14 that is capable of receiving at least a portion of object 18. In particular embodiments, reception unit 26 may receive object 18 in any suitable manner. For example, object 18 may be swiped through reception unit 26, inserted into reception unit 26, received by reception unit 26 in any other suitable manner, or any combination of the preceding. In particular embodiments, reception unit 26 may receive object 18 in order for a user to perform a transaction (or a financial transaction) with device 14. In particular embodiments, reception unit 26 may receive the entire object 18 or only a portion of the object 18. In particular embodiments, device 14 may have more than one reception unit 26. For example, device 14 may include one or more reception units 26 for different types of objects 18. In particular, device 14 may include reception unit 26 for money and a separate reception unit 26 for credit/debit cards.

Reading unit 30 may generally refer to any unit capable of reading data 22 stored on object 18. Reading unit 30 may be capable of reading any suitable type of data 22 stored on any suitable type of object 18. For example, reading unit 30 may read data 22 stored on a debit card, credit card, ticket, boarding pass, passport, driver's license, identification card, money, key fob, metallic key, plastic key, any other object that may be used with device 14, or any combination of the preceding. In particular embodiments, reading unit 30 may implement any suitable technique for reading data 22 stored on object 18. In particular embodiments, reading unit 30 may be further capable of processing the transaction. For example, after reading unit 30 reads data 22 stored on object 18, reading unit 30 may use data 22 to determine whether the transaction should be allowed or denied, gather and process any other data needed in order to process the transaction, perform any other suitable method for processing the transaction, or any combination of the preceding. In particular, if device 18 is a credit card reader used by a person to purchase a product, reading unit 30 may use data 22 to contact a financial institution to gain approval for the purchase, process the approval of the purchase, and finalize the purchase. In particular embodiments, during the processing of the transaction, reading unit 30 may collect and/or generate additional data that may be representative of the transaction, such as the time, date, and/or location of the transaction, the type of transaction, the amount of money involved in the transaction, the type of product purchased, whether or not a transaction was allowed, any other suitable data representative of the transaction performed at device 14, or any combination of the preceding.

Collection unit 34 may generally refer to any suitable unit capable of collecting residue 24 from object 18. Collection unit 34 may collect residue 24 in any suitable manner. For example, collection unit 34 may collect residue 24 using a non-contact vapor collection method, such as drawing (or sucking) in air when object 18 is inserted into device 14 at reception unit 26. In particular, when a credit card is swiped through a credit card reader of device 14, collection unit 34 may draw in the air at (or near) the location where the credit card was swiped. As another example, collection unit 34 may collect residue 24 through a sample from the surface of object 18, such as a sample produced by swabbing object 18. For example, when money is inserted into a vending machine, the money may be swabbed in any suitable manner in order to collect residue 24. In particular embodiments, collection unit 34 may collect residue 24 in any other suitable manner, such as using sample traps, light/laser sources, any other suitable method, or any combination of the preceding. In particular embodiments, after residue 24 is collected, residue 24 may be provided to analysis unit 38 in order to determine whether residue 24 includes an explosive material.

Analysis unit 38 may generally refer to any suitable unit capable of analyzing residue 24 in order to determine whether residue 24 includes an explosive material. Analysis unit 38 may analyze residue 24 in any suitable manner. For example, analysis unit 38 may analyze residue 24 using liquid chromatography, gas chromatography, chemiluminescence, ion mobility spectrometry (IMS), mass spectrometry, electron captured detection methods, surface acoustic wave (SAW) methods, thermo-redox detection methods, field ion spectrometry methods, various spectroscopic methods, scent detection, x-ray machine methods, neutron activation, other machine-implemented explosive detection methods, future explosive material detection methods, or any combination of the preceding. In particular embodiments, analysis unit 38 may determine whether residue 24 includes explosive material by trace detection, where the explosive material is detected by chemical identification of microscopic residues of the explosive compound in the explosive material.

In particular embodiments, analysis unit 38 may be further capable of generating data representative of the explosive material detected. Data representative of the explosive material may include any suitable data. For example, data representative of the explosive material may include an indication that explosive material was detected; an indication of the type of explosive material that was detected; an indication of the amount of explosive material detected; the date, time, and/or location of the detection; a counter indicating the number of times object 18 has tested positive for an explosive material; a weighted factor based at least in part on the identified explosive material, the counter, and/or the amount of explosive material detected; other data associated with the particular explosive material detected; or any combination of the preceding.

In particular embodiments, analysis unit 38 may be further capable of associating the data that is representative of the explosive material with other data and/or images. For example, the data that is representative of the explosive material may be associated with data read from object 18, images generated by image generation unit 42 (discussed below), data representative of a transaction performed at device 14 (such as the time, date, and/or location of the transaction, the type of transaction, the amount of money involved in the transaction, the type of product purchased, whether or not a transaction was allowed, any other suitable data representative of the transaction performed at device 14, or any combination of the preceding), any other suitable data, or any combination of the preceding. As such, in particular embodiments, analysis unit 38 may be capable of associating any and all data and images from a transaction that resulted in the detection of explosive material. As an example, if a transaction using a credit card results in the detection of explosive material, analysis unit 38 may associate the data representative of the explosive material (such as the name of the explosive material) with data read from the credit card (such as data that identifies the owner of the credit card), an image generated by the image generation unit 42 (such as an image of the person inserting the credit card into device 14), and/or any other suitable data representative of the transaction (such as the amount of money involved in the transaction).

In particular embodiments, analysis unit 38 may be further capable of communicating data over network 46 to managing systems 50. Thus, the data representative of the explosive material (and any of the data and/or images that were associated with that data) may be transmitted to managing systems 50. In particular embodiments, analysis unit 38 may include (or be communicatively coupled to) a computer system for performing (or assisting in the performance of) one or more of the operations of analysis unit 38. Example computer systems may include an embedded computer system, a system-on-chip (SOC), a single-board computer system (SBC) (e.g., a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, any other suitable computing system, or a combination of two or more of these. The computer system may include one or more non-transitory, computer-readable memory units capable of storing one or more instructions, and also a processor capable, upon execution of the one or more instructions, of performing (or assisting in the performance of) one or more operations of analysis unit 38. Additional details regarding the computer system of particular embodiments of analysis unit 38 are discussed below with regard to FIG. 3. In particular embodiments, one or more of analysis unit 38 and collection unit 34 may be positioned proximate the reader unit 30 in a manner that minimizes the distance between the units and the object 18. In particular embodiments, this may enhance the accuracy of particular explosive material detections.

Image generation unit 42 may generally refer to any suitable unit for generating one or more images associated with a transaction conducted using device 14. For example, image generation unit 42 may include a camera, video camera, any other suitable image generation device, or any combination of the preceding. In particular embodiments, image generation unit 42 may generate images of the transaction conducted at device 14. As such, one or more pictures or videos may be generated that may identify a user involved in the transaction with device 14. In particular embodiments, the images may be generated in response to object 18 being inserted into device 14. In particular embodiments, the images may be generated for any suitable time prior to and/or after a user inserts object 18 into the device 14. In further embodiments, the images may be generated constantly or for any other suitable amount of time. For example, the images may be generated by a surveillance camera operating 24 hours a day, 7 days a week.

Although image generation unit 42 is illustrated as being included in device 14, in particular embodiments, image generation unit 42 may be merely associated with device 14. For example, image generation unit 42 may be located in a completely different location than device 14, but may be generating images of device 14 and its surroundings. In particular embodiments, the images generated by image generation unit 42 may be transmitted to analysis unit 38, or may be retrieved by analysis unit 38 in any suitable manner.

In particular embodiments, device 14 may include (or be communicatively coupled to) a computer system for performing (or assisting in the performance of) one or more of the operations of device 14. Example computer systems may include an embedded computer system, a SOC, a SBC (e.g., a COM or SOM), a desktop computer system, a laptop or notebook computer system, an interactive kiosk, a mainframe, a mesh of computer systems, a mobile telephone, a personal digital assistant (PDA), a server, any other suitable computing system, or a combination of two or more of these. The computer system may include one or more non-transitory, computer-readable memory units capable of storing one or more instructions, and also a processor capable, upon execution of the one or more instructions, of performing (or assisting in the performance of) one or more operations of device 14. Additional details regarding the computer system of particular embodiments of device 14 are discussed below with regard to FIG. 3.

In particular embodiments, one or more units of device 14 may be capable of operating covertly. Operating “covertly” may refer to any operations that may be conducted without the knowledge of the owner and/or user of object 18. In particular embodiments, collection unit 34 and/or analysis unit 38 may be capable of operating covertly. As such, when a user of object 18 inserts object 18 into device 14 in order to conduct a transaction, the user of object 18 may have no knowledge that residue 24 is being collected from object 18 and analyzed by analysis unit 38. In particular embodiments, since the user of object 18 has no knowledge of the operations of one or more of the units of device 14, the user may not take any steps to remove any residue 24 from object 18 or prevent residue 24 from being transferred to object 18 (such as by wearing gloves).

In particular embodiments, the covert operations of one or more units of device 14 may provide various advantages over typical explosive material detection devices. For example, the operations of explosive material detectors are typically conducted with the knowledge of the people who are being analyzed for explosive materials and/or who own objects that are being analyzed for explosive materials. For example, at an airport, travelers are made aware of the fact that their luggage may be screened for explosive materials. By providing knowledge of such a screening process to the travelers, the travelers are less likely to put explosive materials in their baggage or put their baggage in a position where it could come into contact with explosive materials. Thus, the fact that a person has knowledge of the screening process acts as a deterrent. In particular embodiments, contrary to the deterrent aspects of typical explosive material detectors, the covert operations of one or more units of device 14 may prevent the user of object 18 from knowing that object 18 is being analyzed for explosive materials. As such, the user is less likely to take precautions to prevent the transfer of explosive material residue to objects 18. Therefore, although particular embodiments of device 14 may not deter a person from handling or coming into close proximity with explosive materials, device 14 may help identify threats because the user is unaware of the operations conducted by the units of device 14.

Although reception unit 26, reading unit 30, collection unit 34, analysis unit 38, and image generation unit 42 have been described as separate units, in particular embodiments, two or more of these units may be the same unit. For example, in particular embodiments, reception unit 26 and reading unit 30 may be the same unit. In such an example, the same unit that receives object 18 may be the unit that reads data 22 stored on object 18. As another example, collection unit 34 and analysis unit 38 may be the same unit. In such an example, the same unit may collect residue 24 and also analyze residue 24.

Although reception unit 26, reading unit 30, collection unit 34, analysis unit 38, and image generation unit 42 have been described as each being included in device 14, in particular embodiments, one or more of these units may be located in any other suitable location. For example, one or more of these units may not be included in device 14, but may be coupled to device 14, either physically or communicatively.

According to the illustrated embodiment, system 10 may include more than one device 14. In particular embodiments, system 10 may include any suitable number of devices 14 deployed in any suitable manner. For example, devices 14 may be deployed at various geographic locations throughout a city, county, state, region, nation, continent, some other geographic boundary, or throughout the world. In particular embodiments, devices 14 may be deployed with a higher density throughout particular strategic geographic locations deemed to have a higher than normal risk of acts of terrorism. Increasing the density of devices 14 in those regions may increase the sample size of objects 18 analyzed for explosive materials, thereby increasing the likelihood that an object 18 handled by a terrorist will be tested. In particular embodiments, the locations of devices 14 may be adjusted based on detection patterns registered by system 10, which may reveal modes of operation for particular terrorist cells.

As is stated above, system 10 includes one or more devices 14 communicatively coupled through a network 46 to one or more managing systems 50. Network 46 may comprise all or a portion of one or more of the following: a data bus, a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of any of the preceding.

Managing system 50 generally refers to any suitable combination of hardware and software capable of processing data received from one or more devices 14. For example, managing system 10 may include a computer system for performing (or assisting in the performance of) one or more of the operations of managing system 50. Example computer systems may include an embedded computer system, a SOC, a SBC (e.g., a COM or SOM), a desktop computer system, a laptop or notebook computer system, an interactive kiosk, a mainframe, a mesh of computer systems, a mobile telephone, a personal digital assistant (PDA), a server, any other suitable computing system, or a combination of two or more of these. The computer system may include one or more non-transitory, computer-readable memory units capable of storing one or more instructions, and also a processor capable, upon execution of the one or more instructions, of performing (or assisting in the performance of) one or more operations of managing unit 50. Additional details regarding the computer system of particular embodiments of managing system 50 are discussed below with regard to FIG. 3.

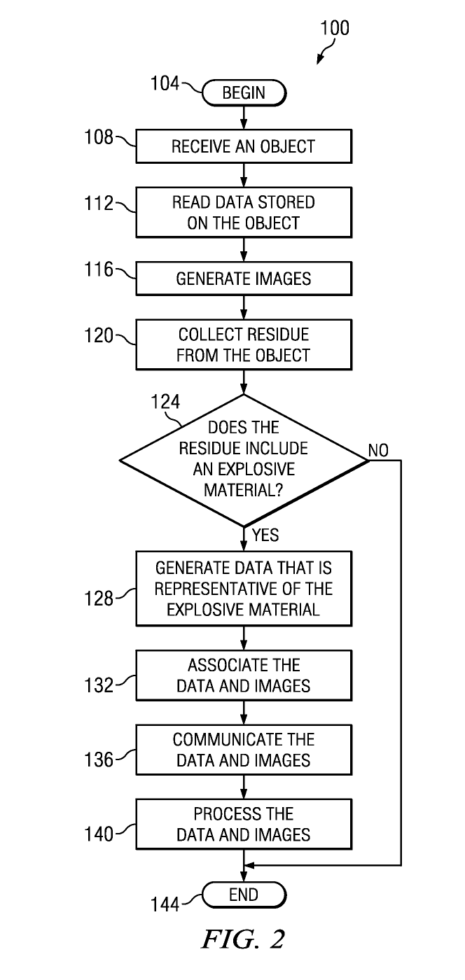

Managing system 50 may be capable of processing data received from one or more devices 14. In particular embodiments, managing system 50 may process the data in order to determine whether a particular detection of an explosive material is a severe threat. In particular embodiments, managing system 50 may be capable of generating a recommendation to contact (or actually contacting) state or federal authorities regarding the detection. In particular embodiments, managing system 50 may be capable of receiving data from multiple devices and processing all of the data. For example, managing system 50 may aggregate the received data and/or correlate the received data. Additional details regarding the processing of the data are discussed with regard to FIG. 2.

In particular embodiments, by utilizing collection unit 30 and analysis unit 34 in connection with device 14, system 10 may provide a number of technical advantages. For example, transaction-based (and financial transaction-based) devices 14 may be used to conduct hundreds or thousands of transactions a day, thereby providing an increased sample size for explosive detections. In certain circumstances, the same object 18 may be analyzed multiple times either by the same device 14 or by different devices 14, thereby enabling verification of prior explosive material detections for that same object 18.

As another example, devices 14 may be used to read objects 18 (such as credit/debit cards) that often come in contact with the object 18 holder's skin and/or clothing and are widely and regularly used. In certain instances, credit/debit cards may be required to conduct particular transactions, such as renting a vehicle or hotel room. Additionally, credit/debit cards tend to be very personal items. Card holders generally do not permit others to handle the card except when required, such as for particular transactions. A detection of explosive residue on a credit/debit card, therefore, may be more closely connected to the card holder.

In addition, system 10 may allow a nonintrusive analysis and detection of explosive material. In particular embodiments, the analysis and detection may occur covertly, such that the owner of the particular object 18 being analyzed is unaware of either the analysis or any resulting detection effected by device 14.

Furthermore, in particular embodiments, when an explosive material is detected, the data representative of the explosive material may be associated with one or more of the data read from object, the generated images, the data representative of a transaction performed at the device, and/or any other suitable data. This may allow the user to be more easily identified and may further allow for gathering of extensive information regarding potential terror threats.

Modifications, additions, or omissions may be made to system 10 without departing from the scope of the disclosure. The components of system 10 may be integrated or separated. For example, one or more units of device 14 may be physically separated from, but in communication with, the other units of device 14. Moreover, the operations of data processing system 10 may be performed by more, fewer, or other components. For example, the operations of device 14 and managing system 50 may be performed by one component, or the operations of managing system 50 may be performed by more than one component. Additionally, operations of system 10 may be performed using any suitable logic.

FIG. 2 illustrates an example method 100 for detecting explosive materials according to one embodiment. In particular embodiments, one or more steps of method 100 may be performed by device 14 of FIG. 1, and/or one or more units of device 14 of FIG. 1. In further embodiments, one or more steps of method 100 may be performed by managing system 50 of FIG. 1.

The method begins at step 104. At step 108, an object is received at a device. In particular embodiments, the object may be any suitable object used to perform a transaction (or financial transaction) with a device, such as a debit card, credit card, ticket, boarding pass, passport, driver's license, identification card (such as an identification card used by an employee in order to gain access to a building), money (bills and/or coins), key fob, metallic key, plastic key, any other object that may be used with a device, or any combination of the preceding. In particular embodiments, the device that receives the object may be a transaction-based device (or a financial transaction-based device), such as an identification card reader, a ticket reader or dispenser, an ATM, a credit/debit card reader, a vending machine, a cash register, any other device used to conduct a transaction (or a financial transaction), or any combination of the preceding.

In particular embodiments, the object may be received at the device in any suitable manner. For example, the object (or a portion of the object) may be inserted into the device, the object (or a portion of the object) may be swiped through a receiving unit of the device, the object may be received by the device in any other suitable manner, or an combination of the preceding.

At step 112, data stored on the object is read. The data may include any suitable type of data that may be used in a transaction (or financial transaction) with the device. For example, the data may include data that identifies the owner of the object, data that identifies one or more accounts associated with the owner of the object, data that identifies one or more financial institutions associated with the owner of the object, data that identifies the object, any other suitable data that may be used in a transaction (or a financial transaction) with the device, or any combination of the preceding. In particular embodiments, the data stored on the object may be read in order to conduct a transaction (or a financial transaction). For example, when a credit card is swiped through a credit card reader in order to purchase a product, the credit card reader may read data that allows the device to approve the purchase of the product. In particular embodiments, the data stored on the object may be read in response to the object being received at the device. In particular embodiments, step 112 may further include processing the transaction (or financial transaction). For example, after the data is read from the object, the data may be used to process the transaction. In particular embodiments, during the processing of the transaction, additional data that may be representative of the transaction (such as the time, date, and/or location of the transaction, the type of transaction, the amount of money involved in the transaction, the type of product purchased, whether or not a transaction was allowed, any other suitable data representative of the transaction performed at device 14, or any combination of the preceding) may be collected and/or generated.

At step 116, images are generated. In particular embodiments, images may be generated by taking video and/or pictures of a user inserting the object into the device. As such, the images may provide further identification of the user of the object. In particular embodiments, the images may be generated in response to the object being inserted into the device. In particular embodiments, the images may be generated for any suitable time prior to and/or after a user inserts the object into the device. In further embodiments, the images may be generated constantly or for any other suitable amount of time. For example, the images may be generated by surveillance camera operating 24 hours a day, 7 days a week.

At step 120, residue is collected from the object. The residue may be collected in any suitable manner. For example, the residue may be collected by drawing in air, swabbing the object, any other suitable method for collecting residue, or any combination of the preceding. In particular embodiments, once the residue is collected from the object, the residue may be analyzed for an explosive material.

At step 124, it is determined whether the residue includes an explosive material. This determination may be made using any suitable technique, such as trace detection, liquid chromatography, gas chromatography, chemiluminescence, IMS, mass spectrometry, electron captured detection methods, SAW methods, thermo-redox detection methods, field ion spectrometry methods, various spectroscopic methods, scent detection, x-ray machine methods, neutron activation, other machine-implemented explosive detection methods, future explosive material detection methods, or any combination of the preceding. If it is determined that the residue does not include an explosive material, the method ends. However, if it is determined that the residue does include an explosive material, the method moves to step 128.

At step 128, data that is representative of the explosive material is generated. In particular embodiments, any suitable data representative of the explosive material may be generated. For example, the data representative of the explosive material may include an indication that an explosive material was detected; an indication of the type of explosive material that was detected; an indication of the amount of explosive material detected; the date, time, and/or location of the detection; a counter indicating the number of times the object has tested positive for an explosive material; a weighted factor based at least in part on the identified explosive material, the counter, and/or the amount of explosive material detected; other data associated with the particular explosive material detected; or any combination of the preceding.

At step 132, the data and images are associated with each other. In particular embodiments, associating the data and images may include associating the data that is representative of the explosive material with one or more of the data read from object, the generated images, data representative of a transaction performed at the device (such as the time, date, and/or location of the transaction, the type of transaction, the amount of money involved in the transaction, the type of product purchased, whether or not a transaction was allowed, any other suitable data representative of the transaction performed at device 14, or any combination of the preceding), any other suitable data, or any combination of the preceding. As an example, if a transaction using a credit card results in the detection of explosive material, data representative of the explosive material (such as the name of the explosive material) may be associated with data read from the credit card (such as data that identifies the owner of the credit card), a generated image (such as an image of the person inserting the credit card into the device), any other suitable data representative of the transaction (such as the type of transaction and the amount of money associated with the transaction), or any combination of the preceding.

In particular embodiments, associating the data and images may include packaging all the data and images related to the detection of the explosive material together so that each of the pieces of data and images may be identified (by a person or a computer) as related to the particular detection of the explosive material. In particular embodiments, associating the data and images may allow the data read from the object, the generated images, and/or the data representative of the transaction to all be time correlated with the transaction that resulted in the detection of the explosive material. In particular embodiments, associating the data and images may allow all of the associated data and images to be processed and/or communicated. For example, associating the data and images may include processing the data and images into one or more data packets for transmittal over a network, such as network 46 of FIG. 1.

At step 136, the data and images are communicated. In particular embodiments, the communicated data and images may include any of the data and images that were associated at step 132. In particular embodiments, the data and images may be communicated to a managing system, such as managing system 50 of FIG. 1. In particular embodiments, this may allow the communicated data and images to be processed.

At step 140, the data and images are processed. In particular embodiments, processing the data and images may include determining whether a particular detection of an explosive material is a severe threat. Severe threats may, for example, be determined based the data generated in step 128. As another example, severe threats may be determined based on detections of particularly dangerous explosive material residue, such as radioactive residue, chemical warfare residue, residue of military grade explosives, or any combination of the preceding. In particular embodiments, processing the data and images may further include generating a recommendation to contact (or actually contacting) state or federal authorities regarding the detection.

In particular embodiments, processing the data and images may include processing the data and images with regard to additional received data. For example, data and images regarding explosive material detection may be received from multiple sources, such as multiple devices 14 of FIG. 1. As such, the data and images received may be aggregated. In particular embodiments, the data and images may be aggregated according to any particular data type, such as geographic region, users that are associated with terrorist groups, explosive material type, any other suitable data type, or any combination of the preceding. For example, if a particular geographic region registers multiple detections of a particular explosive material, the probability of a true threat may be increased and a threat level may need to be raised accordingly. As such, a recommendation may be generated to raise a security threat (or the security threat may be automatically raised) in a particular geographic region.

In particular embodiments, processing the data and images may further include correlating the data and images. For example, a recommendation for the raising or lowering a security level may be generated based on an identity associated with a credit/debit card that has tested positive for explosive material residue. If the card holder is included in a particular watch list, a security level may be raised. In particular embodiments, various statistics and demographics correlated with the card holder may be used to set the security level. At step 144, the method ends.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. Furthermore, any suitable operation or sequence of operations described or illustrated herein may be eliminated. For example, in particular embodiments where the processing of the data and images is performed at the device, the data and images may (or may not) be communicated. Additionally, the acts can operate in an operating system environment or as stand-alone routines occupying all or a substantial part of the system processing.

FIG. 3 is an embodiment of a computer system 200 that may be used in connection with one or more pieces of software used to implement embodiments of the disclosure. In particular embodiments, device 14, analysis unit 38, and/or managing system 50 of FIG. 1 may include (or be communicatively coupled to) one or more computer systems 200 for performing (or assisting in the performance of) one or more of the operations of device 14, analysis unit 38, and/or managing system 50.

Computer system 200 may generally be adapted to execute any of the well-known OS2, UNIX, Mac-OS, Linux, and Windows Operating Systems or other operating systems. The computer system 200 in this embodiment comprises a processor 202, a random access memory (RAM) 204, a read only memory (ROM) 206, a mouse 208, a keyboard 210 and input/output devices such as a printer 214, disk drives 212, a display 216 and a communications link 218. In other embodiments, the computer system 200 may include more, less, or other component parts. Embodiments of the present disclosure may include programs that may be stored in the RAM 204, the ROM 206 or the disk drives 212 and may be executed by the processor 202. The communications link 218 may be connected to a computer network or a variety of other communicative platforms including, but not limited to, a public or private data network; a LAN; a MAN; a WAN; a wireline or wireless network; a local, regional, or global communication network; an optical network; a satellite network; an enterprise intranet; other suitable communication links; or any combination of the preceding. Disk drives 212 may include a variety of types of storage media such as, for example, floppy disk drives, hard disk drives, CD ROM drives, DVD ROM drives, magnetic tape drives or other suitable storage media.

Although FIG. 3 provides one embodiment of a computer that may be used with the disclosure, the disclosure may additionally use any other suitable computer systems. Additionally, embodiments of the disclosure may also employ multiple computer systems 200 or other computers networked together in a computer network. Most commonly, multiple computer systems 200 or other computers may be networked through the Internet and/or in a client server network. Embodiments of the disclosure may also be used with a combination of separate computer networks each linked together by a private or a public network.

Several embodiments may include logic contained within a medium. In the embodiment of FIG. 3, the logic comprises computer software executable on the computer system 200. The medium may include the RAM 204, the ROM 206 or the disk drives 212. In other embodiments, the logic may be contained within hardware configuration or a combination of software and hardware configurations. The logic may also be embedded within any other suitable medium without departing from the scope of the disclosure.

Although the present disclosure has been described with several embodiments, a myriad of changes, variations, alterations, transformations, and modifications may be suggested to one skilled in the art, and it is intended that the present disclosure encompass such changes, variations, alterations, transformation, and modifications as they fall within the scope of the appended claims. For example, although the present disclosure has been described with regard to detecting an explosive material, in particular embodiments, this disclosure further may include detecting any other suitable material, such as drugs, radiation, chemical warfare materials (such as anthrax), or any other suitable illicit material.

What is claimed is:

1. A method comprising:
receiving, at a device operable to read data stored on an object, at least a portion of the object inserted into the device, the data stored on the object comprising data for use in a transaction;
collecting, at the device, residue from the object in response to at least the portion of the object being inserted into the device;
determining that the residue comprises an explosive material;
generating data that is representative of the explosive material; and
communicating the data that is representative of the explosive material.

2. The method of claim 1, wherein the collecting step and the determining step are performed covertly so as to prevent a user of the object from knowing that the steps are being performed.

3. The method of claim 1, wherein the object is selected from a group consisting of:
a debit card;
a credit card;
money;
an identification card; and
a ticket

4. The method of claim 1, wherein the device is selected from a group consisting of:
a device operable to read a debit card;
a device operable to read a credit card;
a device operable to read money;
a device operable to read an identification card; and
a device operable to read a ticket.

5. The method of claim 1, further comprising:
associating data read from the object with the data that is representative of the explosive material; and
communicating the data read from the object.

6. The method of claim 5, wherein the data read from the object is selected from a group consisting of:
data that identifies an owner of the object;
data that identifies an account associated with the owner of the object;
data that identifies one or more financial institutions associated with the owner of the object; and
data that identifies the object.

7. The method of claim 1, further comprising:
generating one or more images of the user of the object while the user is inserting at least the portion of the object into the device;
associating the one or more images with the data that is representative of the explosive material; and
communicating the one or more images.

8. The method of claim 1, further comprising:
associating data representative of the transaction with the data that is representative of the explosive material; and
communicating the data that is representative of the transaction.

9. The method of claim 8, wherein the data that is representative of the transaction is selected from a group consisting of:
data that identifies the transaction type;
data that identifies an amount of money involved in the transaction;
data that identifies a product purchased in the transaction; and
data indicative of whether or not the transaction was allowed.

10. The method of claim 1, further comprising:
receiving the communicated data from the device;
receiving additional data representative of additional explosive material collected from one of a plurality of devices;
aggregating the communicated data and the additional data; and
based at least in part on the aggregation, providing a recommendation regarding a threat level for a particular geographic region.

11. A system comprising:
a reception unit operable to receive at least a portion of an object inserted into the reception unit;
a reading unit operable to read data stored on the object, the data stored on the object comprising data for use in a transaction;
a collection unit operable to collect residue from the object in response to at least the portion of the object being inserted into the reception unit; and
an analysis unit comprising:
one or more non-transitory, computer-readable memory units operable to store one or more instructions; and
a processor operable, upon execution of the one or more instructions, to:
determine that the residue comprises an explosive material;
generate data that is representative of the explosive material; and
communicate the data that is representative of the explosive material.

12. The system of claim 11, wherein the collection unit and the analysis unit are configured to operate covertly so as to prevent a user of the object from knowing that the collection and the determination operations are being performed.

13. The system of claim 11, wherein the object is selected from a group consisting of:
a debit card;
a credit card;
money;
an identification card; and
a ticket

14. The system of claim 11, wherein the reception unit is part of a device selected from a group consisting of:
a device operable to read a debit card;
a device operable to read a credit card;
a device operable to read money;
a device operable to read an identification card; and
a device operable to read a ticket.

15. The system of claim 11, wherein the processor is further operable, upon execution of the one or more instructions, to:
associate data read from the object with the data that is representative of the explosive material; and
communicate the data read from the object.

16. The system of claim 15, wherein the data read from the object is selected from a group consisting of:
data that identifies an owner of the object;
data that identifies an account associated with the owner of the object;
data that identifies one or more financial institutions associated with the owner of the object; and
data that identifies the object.

17. The system of claim 11, wherein:
the system further comprises an image generator operable to generate one or more images of the user of the object while the user is inserting at least the portion of the object into the reception unit; and
the processor is further operable, upon execution of the one or more instructions, to:
associate the one or more images with the data that is representative of the explosive material; and
communicate the one or more images.

18. The system of claim 11, wherein the processor is further operable, upon execution of the one or more instructions, to:
associate data representative of the transaction with the data that is representative of the explosive material; and
communicate the data that is representative of the transaction.

19. The system of claim 18, wherein the data that is representative of the transaction is selected from a group consisting of:
data that identifies the transaction type;
data that identifies an amount of money involved in the transaction;
data that identifies a product purchased in the transaction; and
data indicative of whether or not the transaction was allowed.

20. The system of claim 11, further comprising a managing unit comprising:
one or more additional non-transitory, computer-readable memory units operable to store one or more additional instructions; and
an additional processor operable, upon execution of the one or more additional instructions, to:
receive the communicated data;
receive additional data representative of additional explosive material collected from one of a plurality of devices;
aggregate the communicated data and the additional data; and
based at least in part on the aggregation, provide a recommendation regarding setting a threat level for a particular geographic region.

21. A system comprising:
a reception unit operable to receive at least a portion of an object inserted into the reception unit, wherein the object is selected from a group consisting of:
a debit card;
a credit card;
money;
an identification card; and
a ticket;
a reading unit operable to read data stored on the object, the data stored on the object comprising data for use in a transaction;
a collection unit operable to collect residue from the object in response to at least the portion of the object being inserted into the reception unit;
an analysis unit comprising:
one or more non-transitory, computer-readable memory units operable to store one or more instructions; and
a processor operable, upon execution of the one or more instructions, to:
determine that the residue comprises an explosive material;
generate data that is representative of the explosive material;
associate data read from the object with the data that is representative of the explosive material;
associate data representative of the transaction with the data that is representative of the explosive material; and
communicate the data that is representative of the explosive material, the data read from the object, and the data that is representative of the transaction; and
wherein the collection unit and the analysis unit are configured to operate covertly so as to prevent a user of the object from knowing that the collection and the determination operations are being performed.
